(19) United States
(12) Patent Application Publication
(10) Pub. No.: US 2015/0208574 A1
(43) Pub. Date: Jul. 30, 2015

(54) PERISTALTIC PUMP INJECTION SYSTEM

(71) Applicant: Dryject, Inc., Hatboro, PA (US)

(72) Inventors: Chris des Garennes, Elkton, MD (US); Peter Van Drumpt, Wilmington, NC (US); John Paddock, Hainesport, NJ (US)

(73) Assignee: Dryject, Inc., Hatboro, PA (US)

(21) Appl. No.: 14/605,261

(22) Filed: Jan. 26, 2015

Related U.S. Application Data
(60) Provisional application No. 61/931,448, filed on Jan. 24, 2014.

(51) Int. Cl. A01C 23/02; A01M 17/00

(52) U.S. Cl. CPC A01C 23/028; A01M 17/002

(57) ABSTRACT

A mobile injection device including a peristaltic pump assembly configured to be installed in a device for placing material on or beneath the soil surface. The device delivers material into the soil subsurface as a fluid or a suspension. The peristaltic pump has a rotor assembly that urges a fluid additive in precision amounts through flexible tubes into a manifold. A pressurized fluid is introduced to the manifold to mix the additive in the pressurized fluid and inject the mixture into the ground through an injection nozzle. A computer control system monitors the ground speed of the device and determines the amount of additive to be pumped into the manifold to provide a uniform distribution of the additive to the soil.

### CROSS REFERENCE TO RELATED APPLICATIONS

This application claims the benefit of U.S. patent application No. 61/931,448 filed on Jan. 24, 2014 which is incorporated by reference as if fully set forth.

### INCORPORATION BY REFERENCE

U.S. Pat. No. 7,581,684 filed Sep. 1, 2009 is incorporated by reference as if fully set forth herein.

### FIELD OF INVENTION

This application is generally related to displacement pump systems and more particularly related to a peristaltic pump injection system used in turf maintenance equipment for placing granular or liquid substances below the surface of the ground at a precision depth.

### BACKGROUND

Turf and soil maintenance, for those involved in the golfing industry and turf grass management, plays a critical role in the success of a business. The greens and fairways provide the surface where golfers spend the majority of their time. Proper treatment and maintenance of that surface creates a higher quality product, and provides for a more aesthetically appealing landscape, which creates a highly attractive and desirable field for play.

The introduction of various materials, such as soil amendments, fertilizers, insecticides, and aeration improves the properties of the soil and the growth it supports. Aeration may be used to control compaction, soil temperature, regulate soil moisture, and improve drainage. Timely aeration improves soil texture and the incorporation of certain physical or biological additives prevents the soil from becoming compacted, which impedes overall plant health, germination, root growth, and water transmission.

Historically, the introduction of materials to the soil surface or subsurface was accomplished through use of tillage tools. These tillage tools cut or plow the surface of the soil and release additives into the openings created. The amount of soil eruption and surface disturbance caused by tillage on golf courses results in decreased play by advanced golfers and increased labor costs for cleanup, spreading of soil amendments, and topdressing.

Other methods of introducing materials into the soil have also been used. Techniques such as injection of liquid substances into the subsurface using high pressure water jets, may not be as disruptive to the ground surface, but are generally limited to use of liquid or wet additive materials. These and other methods may involve machinery that is more expensive and require more time.

Thus, a need exists for a faster, more mobile, cost effective system for treating and maintaining a ground surface, while maximizing the number and types of materials usable as additives and the manner these materials are placed below the surface of the soil.

### SUMMARY

A peristaltic pump injection system used in turf maintenance equipment for placing additives, such as liquid materials, into the soil at a precision depth is disclosed. Fluid jets, for example using water or air blasts, carry the materials through the peristaltic pump injection system and into the soil and leave no eruption on the surface to interfere with any immediately following activities or other treatments. This is particularly beneficial where the materials are being added to lawns, putting greens and fairways on golf courses, sports fields and the like.

The additives delivered in a blast can be used to effectively drill a hole in the soil. The hole may have a diameter in the range of 0.1 to 2.0 inches. Substantially simultaneously, the created hole may be filled with a soil additive or amendment. Once the hole has been filled, the surface of the soil is left smooth, with minimal soil disruption and displacement.

The additives are injected into the injection manifold through an upstream valve and high pressure water is injected through a poppet valve assembly, downstream of the valve where the additive materials are injected. The fluid/additives are injected between high pressure blasts into the injection manifold and are mixed in the injection manifold with the high pressure water. In some instances, the fluid/additives may be injected into the dosing material. This results in injected materials that are not damaged by high pressure and allows for complete defusing of the additives into the soil. This mixture is urged through tubes of the peristaltic pump assemblies, at a precision amount, to nozzles and manifolds of the device.

The device fires its nozzles as a function of the distance traveled by the device along its path of travel, e.g. as ground speed sensed over a period of time. A ground speed sensor generates a signal that is calculated as a ground speed by the central controller and used to calculate the distance traveled, or the instantaneous speed. The central controller can adjust the injector rates for the peristaltic pumps, on the go, and for systems using multiple peristaltic pumps, the pumps can be adjusted both individually and together.

Thus, until the device travels its pre-set distance, the next blast from the nozzles may not occur, regardless of whether the device travels quickly or slowly over such distance. In other words, although the spacing between holes may be adjusted by the operator, once a selection is made, that spacing from the beginning of the hole to the beginning of the next hole, remains substantially fixed.

The device may provide deep penetration of additives into the soil, as great as 10 inches in depth and be used to punch through sod. The device may also punch through fiber or stabilized sports turf to allow better root proliferation below a mesh; aerate, amend, and top-dress in one pass, and allow for play on a smooth surface in approximately one hour.

For sake of brevity, this summary does not list all aspects of the present invention, which is described in further detailed below.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there is shown in the drawings embodiments which are presently preferred. It should be understood, however, that the invention is not limited to the precise arrangements shown.

FIG. 1 is a schematic view of a system for injecting an additive into the soil in accordance with a disclosed embodiment.

FIG. 2 is a perspective view of a rotating carriage with an encoder disc in accordance with a disclosed embodiment.

FIG. 3 is a schematic side view of the system of FIG. 1 on a movable platform in accordance with a disclosed embodiment.

FIG. 4 is a flow diagram if a method in accordance with a disclosed embodiment.

To facilitate understanding, identical reference numerals have been used, where possible, to designate identical elements that are common in the figures. The figures are not drawn to scale and may be simplified for clarity. It is contemplated that elements and features of one embodiment may be beneficially incorporated in other embodiments without further recitation.

While described in reference to a system for injecting liquid additives to soil, the present invention may be modified for a variety of applications while remaining within the spirit and scope of the claimed invention, since the range of the potential applications is great, and because it is intended that the present invention be adaptable to many such variations. For example, the system could be used for application if stabilizers to a ground cover other than soil, for example asphalt or macadam.

### DETAILED DESCRIPTION OF THE PREFERRED EMBODIMENTS

Certain terminology is used in the following description for convenience only and is not limiting. The words “front,” “back,” “forward,” “backwards,” “inner,” and “outer” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. A recitation of “into the soil” or the like means to the surface of the soil as well as beneath the surface of the soil unless the context clearly indicated otherwise. The terminology includes the words specifically noted above, derivatives thereof, and words of similar import.

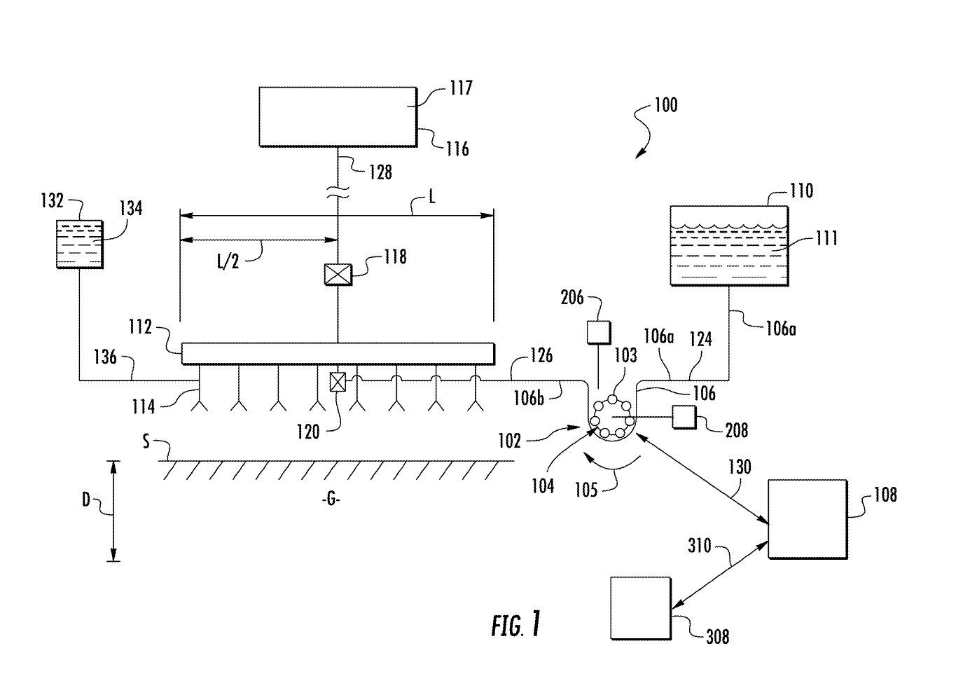

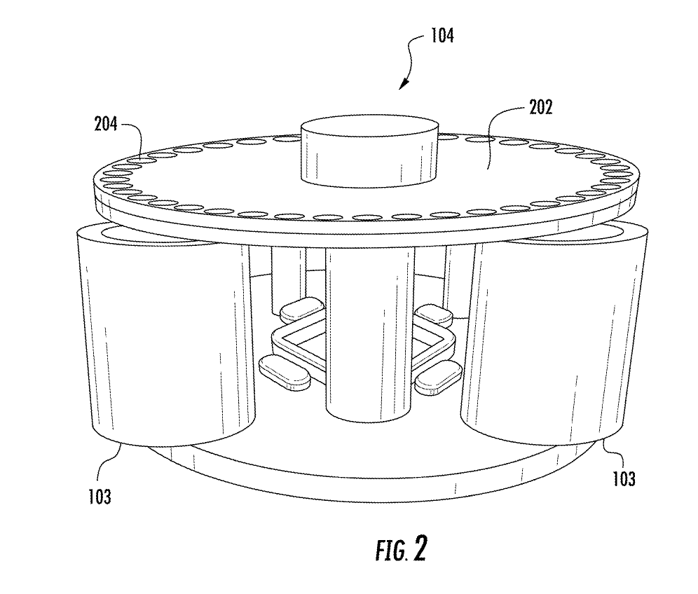

FIG. 1 schematically shows an embodiment of a system 100 for injecting an additive into the soil including a peristaltic pump assembly 102. The peristaltic pump assembly 102 is configured for placing material on or beneath the surface S of a soil system or soil. The device delivers wet material at least to the surface S of the soil and preferably into the soil subsurface to a desired depth D. The peristaltic pump assembly 102 is generally known to include a plurality of rollers 103 supported rotation on a rotating carriage assembly 104. As the carriage 104 rotates as indicated by arrow 105 under the influence of a variable voltage motor 208 (FIGS. 1 and 2), rollers 103 successively compress a resilient tube 106 to urge a material within the tube 106 in the direction of rotation (i.e., corresponding with arrow 105). An axial face of the rotating carriage assembly 104 may include an encoder disc 202. The encoder disc 202 has features 204, for example holes 204, formed around a perimeter of the disc 202 as illustrated in FIG. 2. A sensor 206 (FIG. 1) is positioned to read, or sense, data from the encoder disc 202, for example the number of features 204 passing in a given period of time, and provide that data to a computer control system or controller 108.

A first end 106a of the resilient tube 106 is fluidly coupled to an additive reservoir 110 containing an additive 111. The first end 106a resilient tube 106 may be directly coupled to the reservoir 110 or may have one or more intermediate fluid conduits forming inlet line 124. The additive reservoir 110 contains a liquid additive 111 that may comprise one or more miscible or immiscible liquids or one or more solids suspended in one or more liquids, as in a slurry, or other fluid compositions, such as a gel, suitable for pumping via a peristaltic pump.

A second end 106b of the resilient tube 106 is fluidly coupled to the manifold 112 either directly or through one or more intermediate fluid conduits forming outlet line 126. A check valve 120 is placed in the outlet line 126 between the peristaltic pump 102 and the manifold 112. The check valve 120 is configured to allow flow from the peristaltic pump 102 to the manifold 112 but to prevent or block flow from the manifold to the peristaltic pump 102. The peristaltic pump is controlled to constantly provide an amount of additive to the manifold 112, except for during an injection, discussed below. As the additive 111 flows into the manifold 112, the pressure within the manifold is at or near atmospheric pressure (i.e., 0 pounds per square inch gage) allowing a free flow of the additive. In a preferred embodiment as illustrated, the second end 106b of the resilient tube 106 is coupled with the manifold at a midpoint L/2 of the length L of the manifold via outlet line 126.

The manifold 112 includes a plurality of nozzles 114. In the non-limiting embodiment illustrated schematically in FIG. 1, eight nozzles 114 are shown evenly spaced along the length L, although spacing need not be even. In other embodiments, a greater or lesser number of nozzles 114 may be used with even or uneven spacing. The nozzles 114 are in direct fluid communication with the interior of the manifold 112 as illustrated. In an embodiment, one or more nozzles 114 may have a valved connection with the manifold 112.

A source of pressurized fluid 116 is in fluid communication with the manifold 112 via pressure line 128. In a preferred embodiment, the point of attachment between the manifold 112 and the source of pressurized fluid 116 is at a midpoint L/2 of the length L of the manifold 112 via pressure line 128. In a preferred embodiment, the source of pressurized fluid 116 is attached to the manifold 112 adjacent to the second end of the resilient tube 106.

The source of pressurized fluid 116 may be an accumulator or other device or structure configured to supply a fluid 117 at a substantially constant pressure. As used herein, a pressurized fluid 117 is a fluid at a pressure greater than the surrounding atmospheric pressure. This pressure is sometimes referred to a gage pressure to distinguish it from the total, or absolute, pressure which includes atmospheric pressure. In some embodiments, the pressurized fluid 117 may be at a pressure of up to 4,000 pounds per square inch, for example the pressure of the pressurized fluid 117 may range from about 2,000 pounds per square inch to about 4,000 pounds per square inch.

A valve, for example a poppet valve 118, is placed in the pressure line 128 between the source of pressurized fluid 116 and the manifold 112, preferably adjacent to the manifold 112. The poppet valve 118 is configured to provide a blast or a jet of pressurized fluid 117 to the manifold. Advantageously, the blast or jet of pressurized fluid 117 interacts with the additive 111 delivered to the manifold by the second end of the resilient tube 106b. The interaction of the pressurized fluid 117 and the additive 111 in the manifold evenly, or substantially evenly disperses the additive 111 in the pressurized fluid 117.

The (gage) pressure within the manifold 112 varies from atmospheric pressure to approximately the pressure of the pressurized fluid source 116. Accordingly, a check valve is not included, as the contents of the manifold will not flow in the direction of the pressurized fluid source 116. However, a check valve may be placed in the pressure line to insure the contents of the manifold do not enter the high pressure source 116.

In an embodiment, a hopper 132 containing a dry filler material 134 may be coupled via line 136 to the nozzles 114 (only shown connected to one nozzle 114 in FIG. 1 for clarity). As the injected material travels through the nozzles 114, the velocity of flow causes a vacuum in the nozzles 114 behind the flow. This vacuum can be used to draw the dry material 134 into the nozzle 114 and flow into any void caused in the soil surface S or ground G by the injection. The flow of the dry material 134 into the nozzles 114 can be controlled by a valve at the hopper 132 or individually by valves at the nozzles 114.

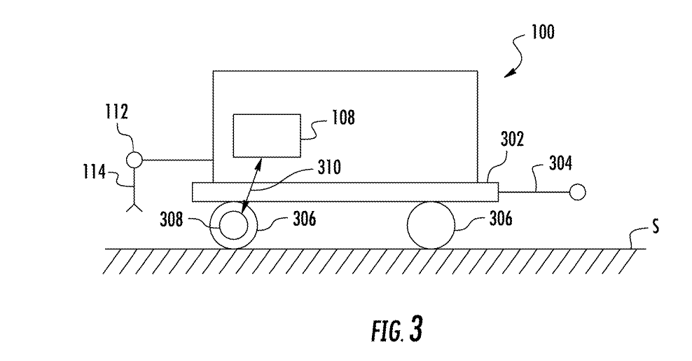

The system 100 can be supported on a platform 302 movable with respect to the surface S of the soil or soil system as illustrated in FIG. 3. The platform 302 can be designed to be pulled or towed and may be attached to, at a hitch 304, a tractor or other vehicle suitable for towing (not shown). The system 100 has wheels 306 that operate as a free-wheel as the system 100 is towed along the surface S. The platform 304 could also be self-propelled with at least one wheel 306 as a drive wheel.

A sensor 308 may be attached to a wheel 306, either free-wheel or drive wheel, for selectively sensing data corresponding to ground speed. In an embodiment, the data relates to angular displacement corresponding to rotations of a wheel 306 of a known diameter. Between the sensor 308 and the controller 108 is a communication link 310 to facilitate communication of ground speed data between the sensor 308 and the controller 108.

In the non-limiting embodiment illustrated in FIG. 3, the entire system 100 is supported on the platform 302 for ease of illustration only. Some components may be supported for movement over the surface S in a separate vehicle. The communication link 310 may be a wired link, or may be a wireless link connection.

When the output motor 208 rotates the carriage assembly 104, rollers 103 compress the resilient tube 106 within a cavity peristaltic pump 102 to draw the additive 111 from the additive reservoir 110 through the first end portion 106a and force the additive 111 through the second end 106b of the resilient tube. In an embodiment, the he carriage assembly 104 can rotate in a clockwise (as illustrated) or counter-clockwise direction and additives in the resilient tube 106 can be urged within the flexible tube in the direction of travel of the rollers 103 (i.e., corresponding with arrow 105 in FIG. 1).

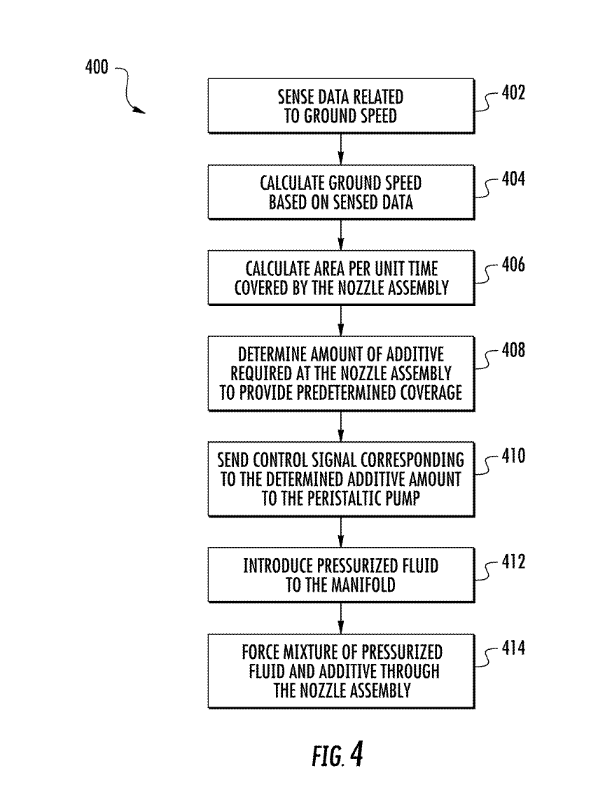

The additives 111 are provided or metered out by the peristaltic pump 102 in precision amounts to the injection manifold 112. This is accomplished by mounting an encoder disc 202 on the carriage assembly 104 (FIG. 2). The encoder disc 202 may be formed from a metal, for example stainless steel, with features, such as holes 204 that are sensed by a sensor 206, for example a Hall Effect proximity sensor. As shown in FIG. 2, the sensor 206, for example a proximity sensor, is mounted to the peristaltic pump housing and detects the absence or presence of metal directly in front of it. In an embodiment the proximity sensor 50 reads the revolutions of the encoder disc 202 per a period of time and reports the revolutions to a computer control system, controller 108 via communication link 130. The communication link 130 may be a wired link or a wireless link to facilitate transmission of at least a control signal from the controller 108 to the motor 208. As illustrated in the non-limiting embodiment of FIG. 4, each through hole 204 in the encoder disc 202 represents 1/40 of the peristaltic pump's 102 volume per 1 revolution. For example, if the peristaltic pump's 102 volume per revolution is 0.16 ounces, each hole would be equal to 0.0036 ounce. As illustrated in FIG. 1, the computer sends a control signal, for example a variable output voltage, to the motor 208 to pump the additive material 111 at a given revolution per period of time. In other words, the controller 108 controls the amount of material that is output from the peristaltic pump 102. The desired amount of material output can be pre-set at the controller 108 and may vary from approximately 3 oz. per 1,000 sq. ft. to approximately 365 oz. per 1,000 sq. ft. The peristaltic pump 102 output is controlled by the controller 108 based on data provided by the sensor 206 and the sensor 308. The sensor 308 provides ground speed data to central controller 108.

As shown in FIG. 1, the additives 111 of the peristaltic pump 102 are provided to the injection manifold 112 through valve, check valve 120, and high pressure fluid, for example water, is injected through a poppet valve assembly 118, adjacent to the valve 120 where the additive materials 111 of the peristaltic pump 102 are provided. When high pressure fluid (e.g., water) is injected into the injection manifold 112, the injection causes the pressure in the manifold 112 to rise. The pressure in the manifold 112 can rise to the same, or substantially the same, pressure as the pressurized fluid source 116. This increase in pressure closes the check valve 120 that allows the additive 111 to flow into the manifold. The pressure within the manifold 112 causes the fluid 117 and the additive 111, mixed under the influence of the fluid 117 jet in the manifold 112, to exit the manifold through the nozzles 114. The nozzles 114 may be in free and open fluid communication with the atmosphere as illustrated, or may include one or more valves to restrict the flow out of the manifold 112.

As the pressure drops in the manifold 112, the check valve moves into an open position and the additives 111 again enter the mixing chamber. Injection of the high pressure fluid 117 into the injection manifold 112 stops the movement of the additive into the injection manifold for duration of approximately 0.05 to 0.30 seconds. During this time period, the pressure in the mixing chamber increases from approximately 0 p.s.i. (gage, therefore corresponding to atmospheric pressure) to approximately 4,000 p.s.i. (gage). After each injection of high pressure fluid 117 into the manifold 112, the pressure in the manifold 112 decreases to approximately 0 p.s.i.; during this period, between high pressure injections, the additives move into the injection manifold 112. The mixture of additives and high pressure water is pumped into the soil as noted below.

During the period when the check valve 120 is closed and the pressure in the manifold 112 is elevated, the carriage assembly 104 of peristaltic pump 102 continues to turn as controlled by the variable voltage motor 208. The second end portion 106b of the resilient tube 106 or the outlet line 126, or both the resilient tube 106 and the outlet line 126, acts as an accumulator for the additive materials 111 pumped during that time period.

The mixture of additives 111 and high pressure fluid 117 is injected into the ground G under high pressure through nozzles 114. The velocity of the high pressure fluid 117 moving through the nozzles 114 allows the mixture to be forced into the soil profile from depths D of approximately 1 to 12 inches. Movement of the high pressure fluid 117 and mixture into the soil creates fractures in the soil. The mixture is then drawn into micro pores in the soil through capillary action.

FIG. 4 is a flow diagram representing a method 400 for injecting an additive to the soil according to a disclosed embodiment. At 402 data related to ground speed of the system 100 is sensed by a sensor, for example sensor 308, which may include an encoder disc mounted to a wheel 306 and a proximity sensor fixed to the movable platform 302. The data is communicated to the controller 108 where the data may be stored.

At 404, the ground speed of the system 100 including at least the manifold 112 and nozzles 114 is calculated at the controller 108 from the data received.

At 406, an area per unit time covered by the nozzle assembly 114 at the calculated ground speed is calculated at the controller 108.

The controller 108 determines at 408 the amount of additive 111 required at the nozzles 114 in order to apply a predetermined amount of additive per unit area to the soil.

At 410, the controller 108 provides a control signal, for example a variable voltage, via the communications link 130 to the peristaltic pump 102 to deliver the determined amount of an additive 111 to the manifold 112. Under the pressure generated by the peristaltic pump 102 in outlet line 106b, the check valve 120 is caused to open, allowing the determined amount of additive 111 to be delivered to the manifold 112.

At 412, poppet valve 118 opens and a pressurized fluid 117 is introduced to the manifold 112. As the pressurized fluid 117 enters the manifold, the check valve 120 is urged to close and the manifold become pressurized to the same, or substantially the same, pressure as the pressurized fluid 117. The pressurized fluid 117 enters the manifold 112 as a jet or a blast and distributed the additive within the manifold 112.

At 414, the pressurized manifold forces the mixture of pressurized fluid and additive through the nozzles 114 and injects the mixture of pressurized fluid and additive into the soil. The sequence can be repeated for a set number of cycles programmed into the controller 108.

Having thus described various methods, configurations, and features of the present poppet valve in detail, it is to be appreciated and will be apparent to those skilled in the art that many physical changes, only a few of which are exemplified in the detailed description above, could be made in the apparatus and method without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A system for injecting an additive into the soil, the system comprising:
a manifold including a plurality of nozzles distributed along a length;
a peristaltic pump assembly that comprises a motor that rotates a carriage assembly, an encoder disc, a sensor, an inlet line fluidly coupled to an additive reservoir, and an outlet line coupled to the manifold;
a pressurized fluid source fluidly coupled to the manifold; and
a ground speed sensor; and
a computer control system in communication with the peristaltic pump assembly and the ground speed indicator,
wherein the computer control system controls an output of the peristaltic pump to be proportional to the ground speed sensed.

2. The system of claim 1, wherein the encoder disc has a plurality of through holes.

3. The system of claim 2, wherein the sensor is a proximity sensor for detecting the plurality of through holes and reports a period of revolution of the peristaltic pump to the computer control system.

4. The system of claim 3, wherein the computer control system maintains digital control of the peristaltic pump and controls the rate of revolution.

5. The system of claim 4, wherein the computer control system sends a variable output voltage to the motor to pump for a predetermined period of revolution and output a predetermined amount of a mixture comprising a portion of the contents of the additive reservoir and a portion of the fluid.

6. The system of claim 5, wherein the mixture is applied to the soil at a predetermined amount per a soil area.

7. The system of claim 6, wherein the computer control system is configured to control injection of the mixture into the soil while the system is in use.

8. The system of claim 1, wherein the pressurized fluid is water at a pressure greater that atmospheric pressure.

9. The system of claim 8, wherein the pressurized fluid is maintained between about 2,000 pounds per square inch and about 4,000 pounds per square inch.

10. The system of claim 9, wherein the pressurized water is maintained in an accumulator.

11. The system of claim 9, further comprising a poppet valve between the accumulator and the manifold.

12. The system of claim 1, wherein the inlet line of the peristaltic pump and the pressurized fluid source are coupled to the manifold at a midpoint of the manifold.

13. The system of claim 1, wherein the system is supported on a platform movable with respect to a surface of the soil.

14. The system of claim 13, wherein the platform is a wheeled platform and the ground speed sensor includes a rotary encoder mounted for rotation with a wheel.

15. The system of claim 1, wherein a check valve is disposed between the peristaltic pump and the manifold.

16. The system of claim 15, wherein the check valve is configured to allow flow from the peristaltic pump to the manifold and block flow from the manifold to the peristaltic pump.

17. A method for injecting an additive into the soil, the method comprising:
sensing data related to ground speed of a nozzle assembly including a plurality of nozzles;
calculating the ground speed from the data;
determining an area per unit time covered by the nozzle assembly at the calculated ground speed;
determining an amount of additive required by the nozzles in order to apply a predetermined amount of additive unit area to the soil;
pumping an amount of an additive via a peristaltic pump and a check valve to a manifold fluidly coupled to the nozzles;
introducing a pressurized fluid to the manifold via a poppet valve to pressurize the manifold and distribute the additive in the pressurized fluid;
injecting the pressurized fluid and additive into the soil through the nozzle via the pressurized manifold.
